(19) United States
(12) Patent Application Publication
(10) Pub. No.: US 2025/0159332 A1
(43) Pub. Date: May 15, 2025

(54) ELECTRONIC DEVICE AND METHOD FOR CONTROLLING ELECTRONIC DEVICE

(71) Applicant: CANON KABUSHIKI KAISHA, Tokyo (JP)

(72) Inventor: YUKI FUKUSHIMA, Kanagawa (JP)

(21) Appl. No.: 18/943,234

(22) Filed: Nov. 11, 2024

(30) Foreign Application Priority Data
Nov. 13, 2023 (JP) 2023-192787

(51) Int. Cl. H04N 23/62; G03B 13/36; H01H 13/64

(52) U.S. Cl. CPC H04N 23/62; G03B 13/36; H01H 13/64

(57) ABSTRACT

An electronic device includes a first operation member that can receive a first operation followed by a second operation and a controller that assigns a function to the first operation and a second operation based on a user selection, performs processes corresponding to the functions assigned to the first and second operations in response to the first and second operations, respectively, and performs control such that if no function is assigned to the first operation, the function to be assigned to the second operation is selected from a first function group and, if a function is assigned to the first operation, a function to be assigned to the second operation is selected from a second function group that includes fewer functions than in the first function group.

### BACKGROUND

### Field

The present disclosure relates to an image pickup device and a method for controlling the image pickup device.

### Description of the Related Art

An image pickup device, such as a digital camera, can perform a user's desired function by assigning a user-selected function (for example, autofocus) to a predetermined operation unit and, thereafter, enable a user to operate the predetermined operation unit during photographing. Image pickup devices have a wide variety of functions as well as autofocus, and thus, the number of functions that users can assign to operation units is increasing.

Some operation units can receive a first operation followed by a second operation and enabling a user to assign a function to the first and second operations. Japanese Patent Laid-Open No. 2001-346080 describes a digital camera equipped with a shutter release button that can be pressed down to a first position level and a second position level. At the first position level, image data representing a moving image is recorded in a storage medium and, at the second position level, image data representing a still image is recorded in the storage medium.

### SUMMARY

The present disclosure provides an electronic device having an operation member that can receive a first operation followed by a second operation and assigning an appropriate function to the first and second operations.

According to an aspect of the present disclosure, an image pickup device includes a first operation member that can receive a first press operation followed by a second press operation having a pressing amount greater than a pressing amount of the first press operation, a memory storing a program, and a controller, that when executing the program, causes the image pickup device to assign a function to the first press operation and the second press operation based on a user selection, perform a process corresponding to the function assigned to the first press operation in response to the first press operation and perform a process corresponding to the function assigned to the second press operation in response to the second press operation, and to perform control such that if no function is assigned to the first press operation, the function to be assigned to the second press operation is selected from a first function group that includes a function related to playback and, if a function is assigned to the first press operation, a function to be assigned to the second press operation is selected from a second function group that includes fewer functions than the first function group and that does not include a function related to playback.

Further features of the present disclosure will become apparent from the following description of exemplary embodiments with reference to the attached drawings.

### BRIEF DESCRIPTION OF THE DRAWINGS

FIG. 1 is a block diagram of the configuration of an image pickup device according to an embodiment.

FIG. 2A is an external view of the front face of the image pickup device.

FIG. 2B is an external view of the rear face of the image pickup device.

FIG. 2C is a configuration diagram of an AF-ON button that can receive multiple operations.

FIG. 3 is a flowchart of a process related to the AF-ON button that can receive multiple operations.

FIGS. 4A to 4D illustrate setting screens used to assign functions to a half press and a full press of the AF-ON button.

FIGS. 5A to 5F illustrate an advanced setting screen used to set a function for a half press and full press in items AF-ON1 to AF-ON7.

FIGS. 6A to 6C are flowcharts of a setting process for assigning a function to a half press and full press of the AF-ON button.

FIGS. 7A to 7D illustrate a method for setting a function to be assigned to a half press and full press of the AF-ON button.

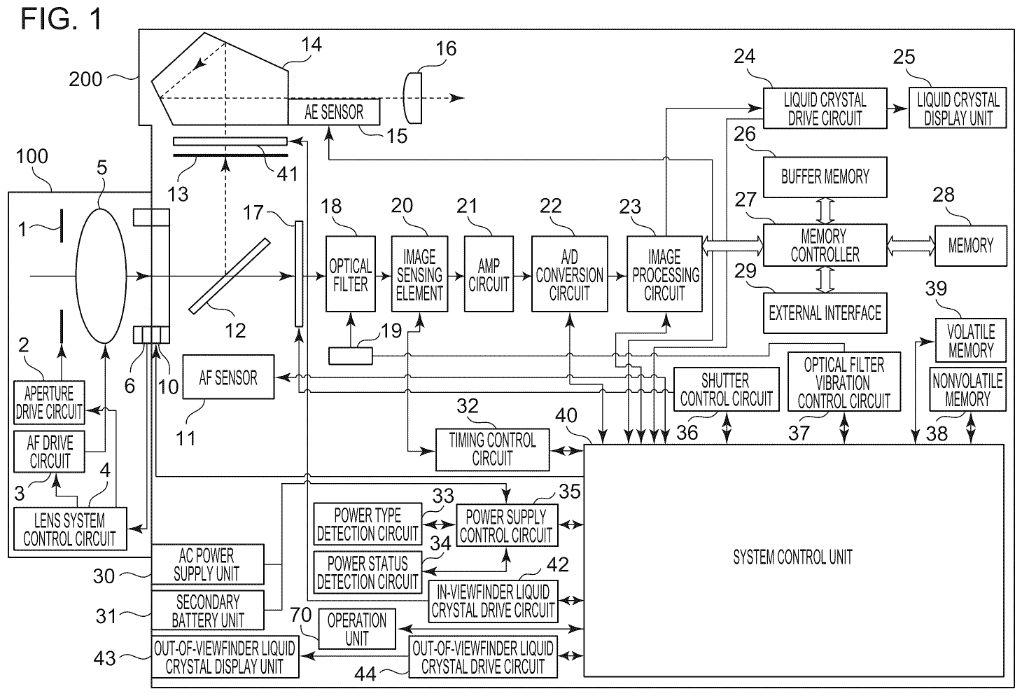

### DESCRIPTION OF THE EMBODIMENTS

Exemplary embodiments of the present disclosure are described below with reference to the accompanying drawings. The same reference numerals are used throughout the accompanying drawings and descriptions to refer to substantially the same functional configurations, and duplicate description is omitted. According to the present embodiment, description is made with reference to an image pickup device 200 as an electronic device. However, the electronic device is not limited thereto.

### First Embodiment

### Configuration of Image Pickup Device

A lens unit 100 includes a lens 5 that is interchangeable. The lens 5 normally consists of multiple lenses. However, for simplicity, in the present embodiment, the lens 5 including only one lens is illustrated.

A communication terminal 6 is provided for the lens unit 100 to communicate with the image pickup device 200, and a communication terminal 10 is provided for the image pickup device 200 to communicate with the lens unit 100.

The lens unit 100 communicates with a system control unit 40 via the communication terminals 6 and 10. The lens system control circuit 4 inside of the lens unit 100 controls an aperture 1 via the aperture drive circuit 2 and focuses the lens 5 by displacing the position of the lens 5 via an AF drive circuit 3. The system control unit 40 also acquires the maximum aperture value and the minimum aperture value of the lens unit 100 via the communication terminals 6 and 10.

An AE sensor 15 measures the brightness of a subject through the lens unit 100.

An AF sensor 11 outputs the defocus amount information to the system control unit 40. The system control unit 40 controls the lens unit 100 based on the defocus amount information.

A quick return mirror 12 is moved up and down by an actuator (not illustrated) during exposure based on an instruction from the system control unit 40.

A user can confirm whether the focus and framing of the optical image of the subject obtained through the lens unit 100 are right by observing a focusing screen 13 through a pentaprism 14 and a viewfinder 16.

A focal plane shutter 17 is a focal plane shutter that can freely control the exposure time of an image sensing element 20 under the control of the system control unit 40.

An optical filter 18 is generally a lowpass filter or the like, which cuts the high frequency component of the light coming in from the focal plane shutter 17 and guides the subject image to the image sensing element 20.

The image sensing element 20 is generally a CCD (Charge Coupled Device) or CMOS (Complementary Metal-Oxide-Semiconductor). The image sensing element 20 captures the subject image formed on the image sensing element 20 through the lens unit 100 in the form of an electrical signal by photoelectric conversion.

An AMP circuit 21 amplifies the captured electrical signal with a gain corresponding to a set image capturing sensitivity.

An A/D conversion circuit 22 converts an analog signal that has been converted into an electrical signal by the image sensing element 20 into a digital signal.

An image processing circuit 23 performs filter processing, color conversion processing, and gamma/knee processing on the image data converted into a digital signal by the A/D conversion circuit 22 and outputs the image data to a memory controller 27. The image processing circuit 23 incorporates a D/A conversion circuit. The image processing circuit 23 can also convert image data converted into a digital signal by the A/D conversion circuit 22 and image data input by the memory controller 27 into analog signals and output the analog signals to a liquid crystal display unit 25 via a liquid crystal drive circuit 24. The image processing and the display processing performed by the image processing circuit 23 are switched by the system control unit 40. The system control unit 40 also performs white balance adjustment based on color balance information regarding the captured image.

The liquid crystal display unit 25 is a rear monitor for displaying an image. Instead of a liquid crystal display unit, any display unit that displays an image can be employed. A display unit of another type, such as an organic EL (Electro Luminescence) display unit, can be employed.

The memory controller 27 stores unprocessed image data input from image processing circuit 23 in a buffer memory 26 and stores image data subjected to image processing in a storage medium (memory) 28. The memory controller 27 retrieves image data from the buffer memory 26 or the memory 28 and outputs the image data to the image processing circuit 23.

The memory controller 27 can also store image data sent via an external interface 29 in the memory 28 and output image data stored in the memory 28 external to the external interface 29. Examples of an external interface include USB, IEEE, and HDMI®.

The memory 28 is a removable storage medium, such as a memory card. However, the memory 28 can be an internal memory. The system control unit 40 controls the drive timing of the image sensing element 20 via a timing control circuit 32.

A power supply control circuit 35 is a circuit that controls the power supplied from an AC power supply unit 30 or a secondary battery unit 31. The power supply control circuit 35 turns the power supply on and off upon receiving an instruction from the system control unit 40. The power supply control circuit 35 also notifies the system control unit 40 of the current power supply status information detected by a power status detection circuit 34 and the current power type information detected by the power type detection circuit 33.

The system control unit 40 controls the focal plane shutter 17 via the shutter control circuit 36.

An optical filter vibration control circuit 37 vibrates a piezoelectric element 19 connected to the optical filter 18. The optical filter vibration control circuit 37 causes the piezoelectric element 19 to vibrate in a predetermined axial direction of vibration, with amplitude of a predetermined value, and for a predetermined vibration time, based on an instruction from the system control unit 40.

A nonvolatile memory 38 is a nonvolatile storage medium that can store set values, such as a shutter speed, aperture value, an image capturing sensitivity, and other various data set by the user, even when the image pickup device 200 is not powered on.

A volatile memory 39 can store data to be temporarily stored, such as the internal status of the image pickup device and information about the removable memory 28.

An in-viewfinder liquid crystal display unit 41 displays, via an in-viewfinder liquid crystal drive circuit 42, a frame indicating the focus measurement point currently in autofocus and icons indicating the camera setting statuses.

An out-of-viewfinder liquid crystal display unit 43 displays, via an out-of-viewfinder liquid crystal drive circuit 44, various camera setting values including the shutter speed and the aperture.

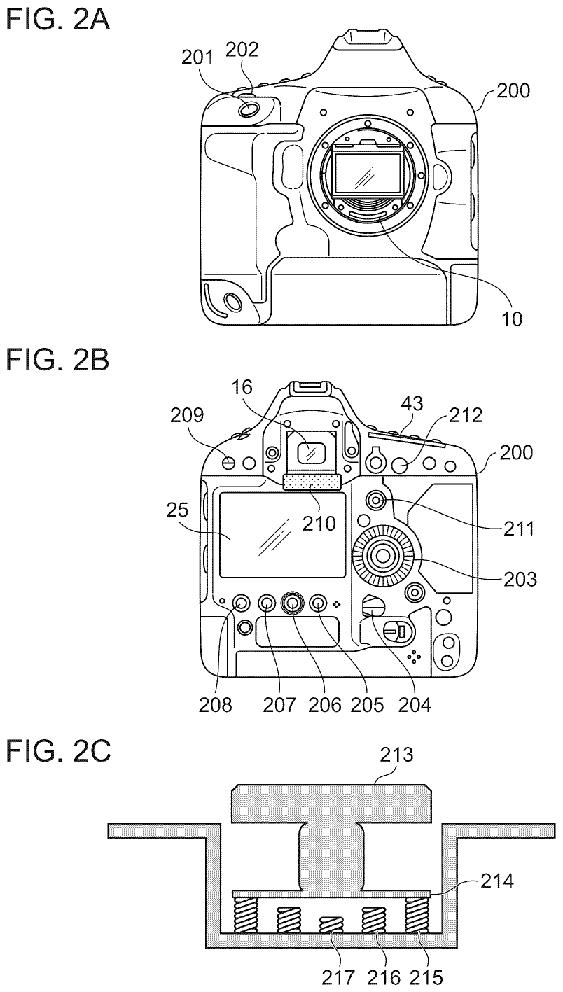

An operation unit 70 includes various operating members each serving as an input unit that receives the operation performed by the user. As illustrated in FIGS. 2A to 2C, the operation unit 70 include a shutter release button 201, an electronic main dial 202, an electronic sub-dial 203, a power switch 204, and a protect button 205. As illustrated in FIGS. 2A to 2C, the operation unit 70 further includes a delete button 206, an enlargement mode button 207, a playback instruction button 208, a menu button 209, A viewfinder on detection unit 210, a multi-controller 211, an AF-ON button 212, and a four-way operational key.

The system control unit 40 is a control unit that controls each unit included in the image pickup device 200. The system control unit 40 uses the volatile memory 39 as a working memory, loads a program stored in the nonvolatile memory 38 onto the volatile memory 39, and executes a program to perform various processes described below.

### Description of External View of Image Pickup Device

FIG. 2A is an external view of the front face of the image pickup device 200, and FIG. 2B is an external view of the rear face of the image pickup device 200.

The shutter release button 201 is used to give a shooting preparation instruction and an image shooting instruction. When the button is pressed down halfway, the brightness of the subject is measured, and the image pickup device 200 focuses on the subject. When the button is fully pressed down, the shutter is released, and the image of the subject is shot.

The electronic main dial 202 is a rotary operating member. By turning the electronic main dial 202, the user sets the shutter speed, aperture, and other setting values, or fine-tunes the enlargement ratio in an enlargement mode.

The electronic sub-dial 203 is a rotary operating member. By turning the electronic sub-dial 203, the user sets the aperture, exposure compensation, and other setting values or performs an image-by-image playback operation in an image display mode.

The power switch 204 is an operating member for turning the power on and off.

The protect button 205 is used to perform a process, such as protection or rating, on an image stored in a storage medium inside or outside of the image pickup device 200.

The delete button 206 is a button used to delete an image stored in the storage medium inside or outside of the image pickup device 200.

The enlargement mode button 207 is a button that receives an operation to provide an instruction to enter the enlargement mode (start of the enlargement mode) and an instruction to exit from the enlargement mode (end of enlargement mode) in the playback mode.

The playback instruction button 208 is a button used to display an image stored in the storage medium inside or outside of the image pickup device 200 on the liquid crystal display unit 25.

The menu button 209 is used to display a variety of setting screens on the liquid crystal display unit 25.

The viewfinder on detection unit 210 is a sensor to detect whether the user looks through the viewfinder 16.

The multi-controller 211 is an operating member that can be operated in multiple directions to set the focus measurement point, which is the starting point for autofocusing, or to move the enlarged frame (enlarged area) when an enlarged image is displayed.

### Configuration of AF-ON Button

The AF-ON button 212 is an operating member used to instruct the camera to start autofocusing on a subject in an image. FIG. 2C is a configuration diagram of the AF-ON button 212, which enables multiple operations. The AF-ON button 212 has a two-stage configuration, with the first stage (hereinafter referred to as “half press”) and the second stage (hereinafter referred to as “full press”) allowing input in each.

A key top 213 is configured to be exposed on the exterior as a part that the user first touches when pressing the AF-ON button 212.

A conductive member 214 is connected to the key top 213 and is configured to be depressed by a force applied from the top.

A ground spring 215 is connected to the conductive member 214 and is installed on ground.

A half press detection spring 216 of the AF-ON button 212 is configured to be brought into contact with the conductive member 214 that is lowered by the force applied from the key top 213. Since the conductive member 214 is connected to the ground spring 215 that is connected to the ground, a half press is detected when the conductive member 214 and the half press detection spring 216 of the AF-ON button 212 come into contact with each other.

A full press detection spring 217 of the AF-ON button 212 is configured to be brought into contact with the conductive member 214 that is lowered by the force applied from the key top 213. Like the half press detection spring 216 of the AF-ON button 212, a full press is detected when the conductive member 214 and the full press detection spring 217 of the AF-ON button 212 come into contact with each other.

In addition, the full press detection spring 217 of the AF-ON button 212 is configured to have a lower height than the half press detection spring 216 of the AF-ON button 212. This configuration always ensures detection of the half press of the AF-ON button 212 when a full press of the AF-ON button 212 is detected. That is, when the half press and full press are detected in this order, the function assigned to the half press and the function assigned to the full press are started in this order, and thus, while the function assigned to the full press is being performed, the function assigned to the half press is continuously performed.

### Processing Related to AF-ON Button

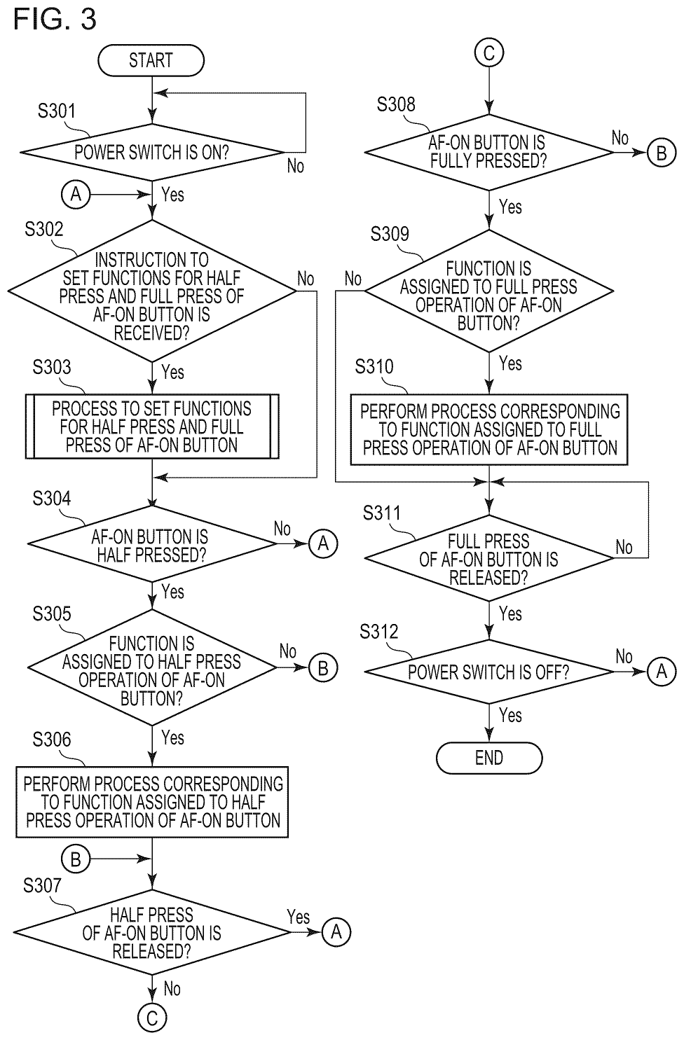

The processing related to the AF-ON button 212, which can accept multiple operations, will now be described with reference to the flowchart illustrated in FIG. 3. The flow of the processing is the flow indicating the processing related to the AF-ON button 212 in a shooting mode of the image pickup device. Simultaneously with the processing, other processing, such as image shooting processing, is performed in response to the shutter button operation. The processing is performed by loading a program stored in the nonvolatile memory 38 into the volatile memory 39 and causing the system control unit 40 to execute the program.

In S301, the system control unit 40 determines whether the power switch 204 is ON. If the power switch 204 is ON, the processing proceeds to S302. Otherwise, the processing returns to S301.

In S302, the system control unit 40 determines whether an instruction is received from the user to do the setting for assigning a function to a half press and full press of the AF-ON button 212. If the system control unit 40 determines that an instruction is received to do the setting for assigning a function to a half press and full press of the AF-ON button 212, the processing proceeds to S303. Otherwise, the processing proceeds to S304.

In S303, the system control unit 40 performs a setting process to assign a function to a half press and a full press of the AF-ON button 212. The process is described in more detail below.

In S304, the system control unit 40 determines whether the AF-ON button 212 is half pressed by the user. If it is determined that the AF-ON button 212 is half pressed, the processing proceeds to S305. Otherwise, the processing returns to S302.

In S305, the system control unit 40 determines whether a function has been assigned to the half press operation of the AF-ON button 212. If it is determined that a function has been assigned to the half press operation of the AF-ON button 212, the processing proceeds to S306. Otherwise, the processing proceeds to S307 without performing S306. If no function is assigned to the half press operation of the AF-ON button 212, the text “disabled” is displayed in an item that indicates the function set for a half press of the AF-ON button 212 in a setting screen 400 and an advanced setting screen 500 (both described below).

In S306, the system control unit 40 performs the process corresponding to the function assigned to the half press operation of the AF-ON button 212.

In S307, the system control unit 40 determines whether the half press of the AF-ON button 212 is released. If it determines that the half press of the AF-ON button 212 is released, the processing returns to S302. Otherwise, the processing proceeds to S308.

In S308, the system control unit 40 determines whether the AF-ON button 212 is fully pressed by the user. If it is determined that the AF-ON button 212 is fully pressed, the processing proceeds to S309. Otherwise, the processing returns to S307.

In S309, the system control unit 40 determines whether a function has been assigned to the full press operation of the AF-ON button 212. If it is determined that a function has been assigned to the full press operation of the AF-ON button 212, the processing proceeds to S310. Otherwise, the processing proceeds to S311 without performing the process in S310.

In S310, the system control unit 40 performs the process corresponding to the function assigned to the full press operation of the AF-ON button 212.

In S311, the system control unit 40 determines whether the full press of the AF-ON button 212 is released. If it is determined that the full press of the AF-ON button 212 is released, the processing proceeds to S312. Otherwise, the processing returns to S311. However, if the full press of the AF-ON button 212 is released in S311, the processing can return to S304, and if the half press of the AF-ON button 212 is continuously performed, the function assigned to the half press can be performed.

In S312, the system control unit 40 determines whether the power switch 204 is OFF. If the power switch 204 is OFF, the processing ends. Otherwise, the processing returns to S302.

### Setting Screen for Assigning Functions to Half Press and Full Press of AF-ON Button

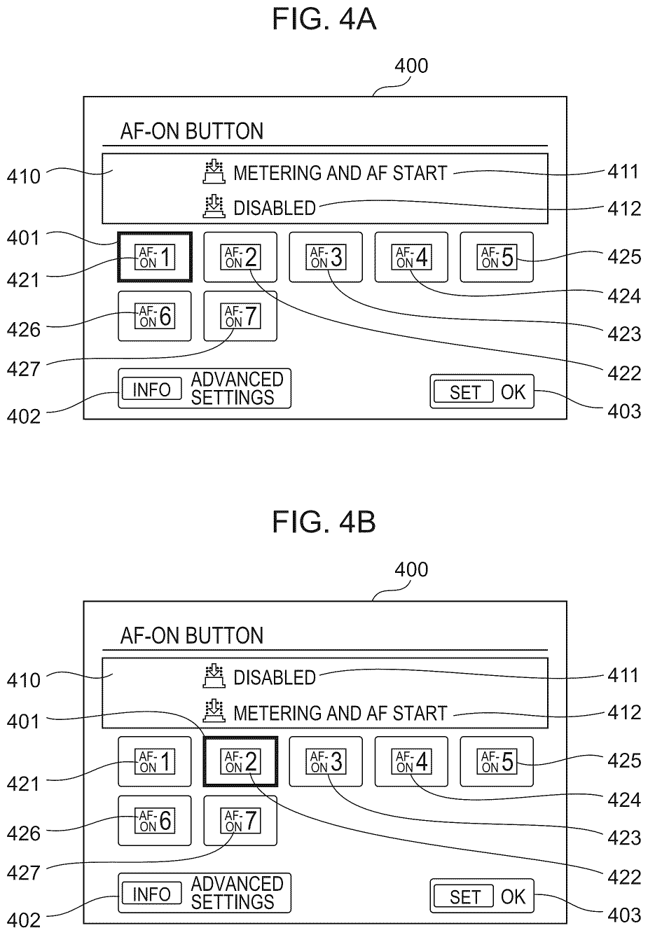

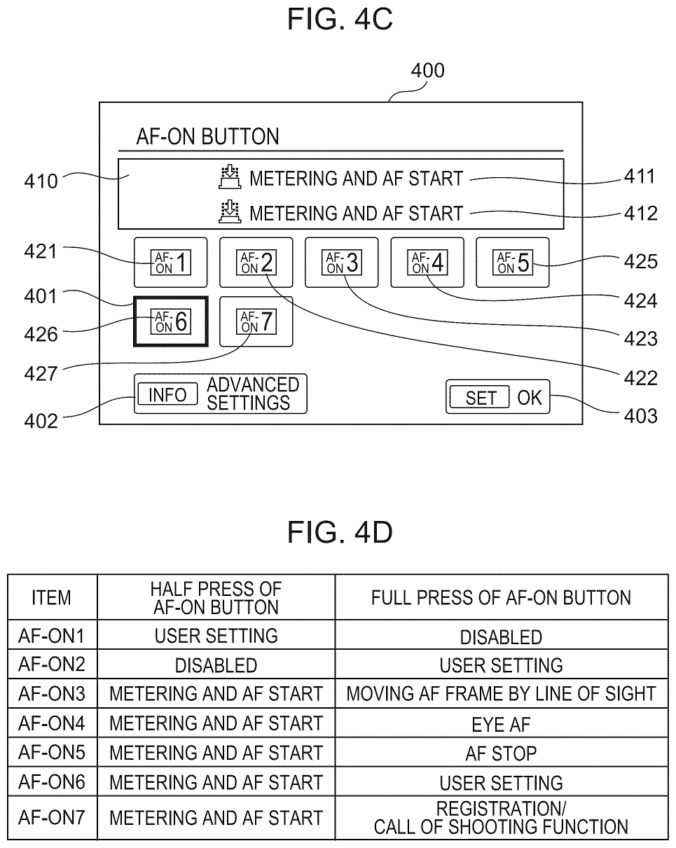

FIGS. 4A to 4C illustrate the setting screen 400 for assigning a function to a half press or full press of the AF-ON button. The setting screen 400 for assigning a function to a half press and full press of the AF-ON button displays options of items 421 to 427 each indicating a combination of the functions settable to a half press or full press of the AF-ON button 212. In addition, the setting screen 400 for assigning a function to a half press or full press of the AF-ON button displays a cursor 401 indicating the currently selected item, a settings display field 410 for the currently selected item, an advanced setting icon 402, and an OK icon 403.

The user can operate a four-way operational key to move the cursor 401 onto any one of the items 421 to 427 and, thus, can change the currently selected item. The items 421 to 427 correspond to AF-ON1 to AF-ON7, respectively. The combinations of functions settable for a half press and full press of the AF-ON button in AF-ON1 to AF-ON 7 are predetermined as illustrated in FIG. 4D and stored in the nonvolatile memory 38. The initial setting of “user setting” for the half press in AF-ON1, the full press in AF-ON2, and the full press in AF-ON6 is “metering and AF start”. However, the user can change the function set for the half press in AF-ON1, the full press in AF-ON2, and the full press in AF-ON6. If the function is changed, the system control unit 40 updates the information regarding the combination of functions settable for the half press and full press that is stored in the nonvolatile memory 38. In addition, the system control unit 40 reads the information regarding the combination of functions settable for the half press and full press stored in the nonvolatile memory 38 to identify the functions set for each item.

The settings display field 410 displays a setting 411 for a half press of the AF-ON button and displays a setting 412 for a full press of the AF-ON button that are settings for the selected item. If the user is allowed to change the settings 411 and 412, the setting is displayed in a normal display mode. If the user is not allowed to change the settings 411 and 412, the setting is displayed in a grayed out display mode. According to the present embodiment, if the user is not allowed to change a setting, the setting is displayed in a grayed out display mode. However, another method can be employed to distinguish a changeable setting from an unchangeable setting.

FIG. 4A illustrates the setting screen 400 in which AF-ON1 (the item 421) is selected with the cursor 401, and the function set for a half press of the AF-ON button is “metering and AF Start” as the initial setting. The text “disabled” is displayed for the full press of the AF-ON button because no function is set for the full press.

The function set for the half press of the AF-ON button can be changed to any function desired by the user. In contrast, no function is set for the full press of the AF-ON button, and the user cannot change the function. For this reason, the setting 411 is displayed in a normal display mode, and the setting 412 is displayed in a grayed out display mode.

FIG. 4B illustrates the setting screen 400 in which AF-ON2 (the item 422) is selected with the cursor 401, and the text “disabled” is displayed for a half press of the AF-ON button, because no function is set for the half press. Since no function is set for the half press of the AF-ON button, the user cannot change the function. The function set to a full press of the AF-ON button is “metering and AF start” as the initial setting. The function set for the full press of the AF-ON button can be changed to a user's desired function. For this reason, the setting 411 is displayed in a grayed out display mode, and the setting 412 is displayed in a normal display mode.

FIG. 4C illustrates the setting screen 400 in which AF-ON6 (the item 426) is selected with the cursor 401, and the function set for a half press of the AF-ON button is “metering and AF Start”. The function set for a full press of the AF-ON button is “Metering and AF start” as the initial setting. Because the function set for the half press of the AF-ON button is fixed, the user cannot change the function. In contrast, the function set for the full press of the AF-ON button can be changed to a user's desired function. For this reason, the setting 411 is displayed in a grayed out display mode, and the setting 412 is displayed in a normal display mode.

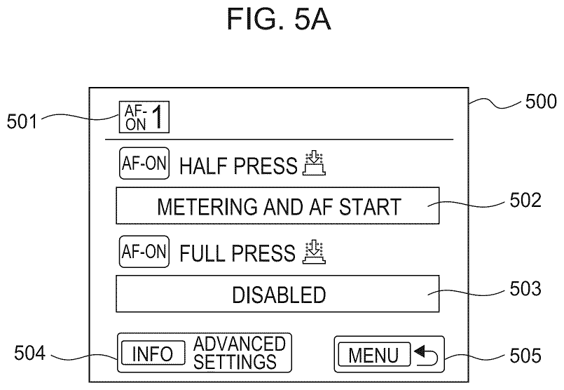

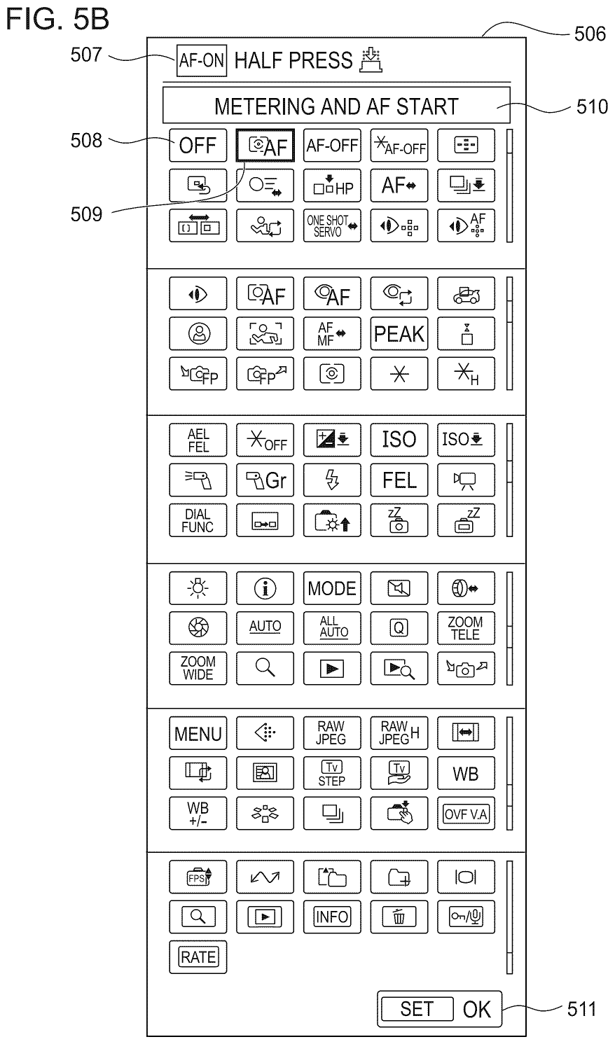

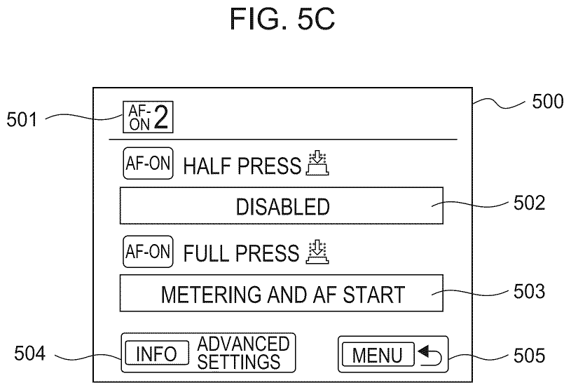

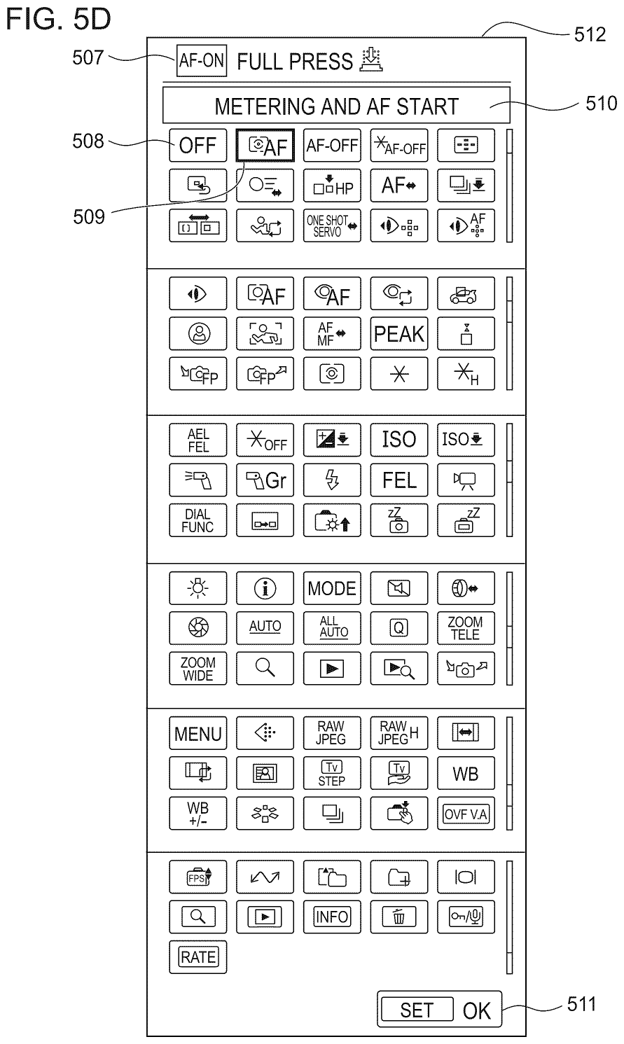

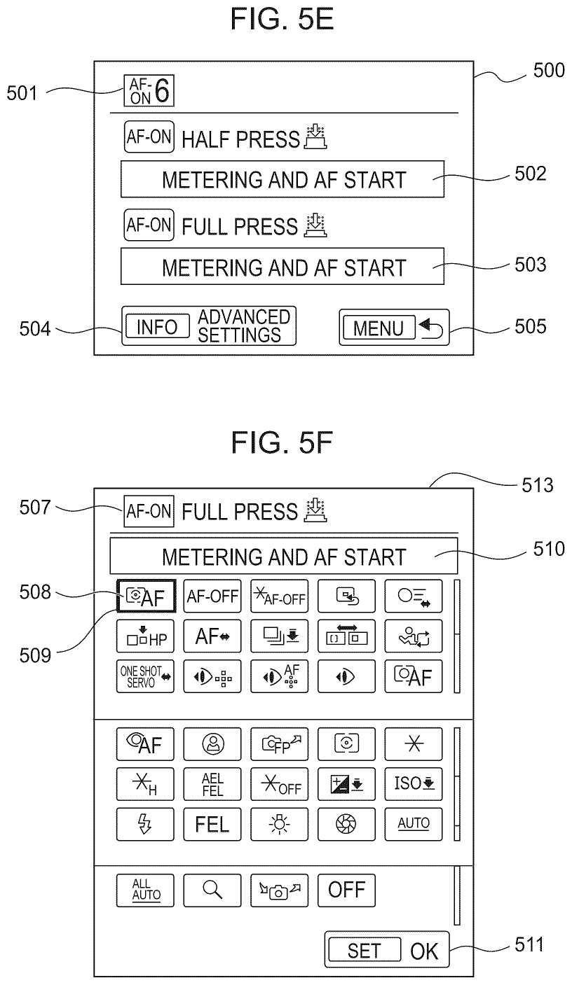

The advanced setting icon 402 indicates that by pressing an INFO button (not illustrated) of the image pickup device 200, the user can perform an advanced setting process. Alternatively, the touch operation performed on the advanced setting icon 402 enables the user to perform the advanced setting process. When the INFO button is pressed or the advanced setting icon 402 is touched by the user, the advanced setting screen 500 (FIG. 5A, 5C, or 5E) described below is displayed.

The OK icon 403 indicates that pressing a SET button (not illustrated) of the image pickup device 200 determines the settings for the half press and full press of the AF-ON button. Alternatively, the settings for a half press and full press of the AF-ON button can be determined by the touch operation performed on the OK icon 403. That is, when the SET button is pressed or the OK icon 403 is touched by the user, the settings 411 and 412 displayed in the settings display field 410 are determined as the settings for half press and full press of the AF-ON button, respectively.

### Advanced Setting Screen for Setting Functions for Half Press and Full Press in Each of Items

FIGS. 5A, 5C, and 5E illustrate an advanced setting screen 500 for setting the functions for half and full presses in the items corresponding to AF-ON1 to AF-ON7 by changing the functions through a user operation. The advanced setting screen 500 displays an item name 501 of the item for which advanced setting is to be made, a setting 502 for a half press of the AF-ON button, a setting 503 for a full press of the AF-ON button, an advanced setting icon 504, and a return icon 505.

FIG. 5A illustrates the advanced setting screen 500 for AF-ON1 and, therefore, an icon indicating AF-ON1 is displayed as the item name 501. The setting 502 for a half press is “user setting” and can be changed by the user. In FIG. 5A, the “Metering and AF start” function is set as the initial setting for the half press of the AF-ON button. As the setting 503 for a full press, “disabled” is displayed to indicate that no function is set for the full press of the AF-ON button.

The setting for a half press in AF-ON1 can be changed by the user and, thus, is displayed in a normal display mode, whereas the setting for a full press in AF-ON 1 cannot be changed by the user and, thus, is displayed in a grayed out display mode.

The advanced setting icon 504 indicates that by pressing the INFO button (not illustrated) of the image pickup device 200, the user can perform the advanced setting process. Alternatively, the touch operation performed on the advanced setting icon 504 can allow the user to perform the advanced setting process. When the INFO button is pressed or the advanced setting icon 504 is touched by the user, a function list screen 506 (FIG. 5B) is displayed that enables the user to configure the setting for the half press in the item corresponding to AF-ON1.

The function list screen 506 displays an operation name 507 of the operation (half press or full press) for which the function selected on the function list screen 506 is set, function icons 508 corresponding to the functions that can be set, a cursor 509, a character string 510 indicating the function currently selected with the cursor 509, and an OK icon 511.

The function list screen 506 illustrated in FIG. 5B displays “half press” as the operation name 507 because the function list screen 506 is a screen used to set a function for the half press in the item corresponding to AF-ON1. In addition, the function icons of a first function group are displayed as the function icons 508 corresponding to the functions that can be set. When the SET button is pressed or the OK icon 511 in the function list screen 506 is touched by the user, the function set for the half press in the item corresponding to AF-ON1 is changed to the function selected with the cursor 509, and the function list screen 506 returns to the advanced setting screen 500. Then, the function selected on the function list screen 506 is displayed on the advanced setting screen 500 as the setting 502 for a half press. When a MENU button is pressed or the return icon 505 is touched by the user on the advanced setting screen 500, the advanced setting screen 500 returns to the setting screen 400.

FIG. 5C illustrates the advanced setting screen 500 for AF-ON2, and therefore, an icon indicating AF-ON2 is displayed as the item name 501. As the setting 502 for a half press, “disabled” is displayed, which indicates that no function is set for a half press of the AF-ON button. As the setting 503 for a full press, “user setting” is displayed, and the setting 503 for a full press can be changed by the user. In FIG. 5C, the “metering and AF start” function is set as the initial setting for the full press of the AF-ON button.

The setting 503 for a full press in AF-ON2 can be changed by the user and, thus, is displayed in a normal display mode, whereas the setting 502 for a half press in AF-ON 2 cannot be changed by the user and, thus, is displayed in a grayed out display mode.

When the user presses the INFO button or touches the advanced setting icon 504, a function list screen 512 is displayed that displays a list of functions each can be set for the full press in the item corresponding to AF-ON2 (FIG. 5D).

The function list screen 512 illustrated in FIG. 5D is a screen used to set a function for a full press in the item corresponding to AF-ON2 and, thus, “full press” is displayed as the operation name 507. In addition, the function icons of a third function group are displayed as the function icons 508 corresponding to the functions that can be set. When the user presses the SET button or touches the OK icon 511 in the function list screen 512, the function set for a full press in the item corresponding to AF-ON2 is changed to the function selected with the cursor 509, and the function list screen 512 returns to the advanced setting screen 500. Then, the function selected on the function list screen 512 is displayed as the setting 503 for a full press on the advanced setting screen 500. When the MENU button is pressed or the return icon 505 is touched by the user on the advanced setting screen 500, the advanced setting screen 500 returns to the setting screen 400.

FIG. 5E illustrates the advanced setting screen 500 for AF-ON6 and, thus, an icon indicating AF-ON6 is displayed as the item name 501. The setting 502 for a half press indicates that the “metering and AF start” function is set for the half press of the AF-ON button. The setting 503 for a full press is “user setting” and, thus, can be changed by the user. In FIG. 5E, the “metering and AF start” function is set for a full press of the AF-ON button as the initial setting.

The setting 503 for a full press in AF-ON6 can be changed by the user and, thus, is displayed in a normal display mode, whereas the setting 502 for a half press in AF-ON 6 cannot be changed by the user and, thus, is displayed in a grayed out display mode.

When the user presses down the INFO button or touches the advanced setting icon 504, a function list screen 513 is displayed that displays a list of all the functions each can be set for the full press in AF-ON6 (FIG. 5F).

The function list screen 513 illustrated in FIG. 5F is a screen used to set a function for the full press in the item corresponding to AF-ON6 and, thus, “full press” is displayed as the operation name 507. In addition, the function icons of a second function group are displayed as the function icons 508 corresponding to the functions that can be set. When the user presses the SET button or touches the OK icon 511 in the function list screen 513, settings are configured so that the function set for the full press of the AF-ON button is changed to the function selected with the cursor 509, and the function list screen 513 returns to the advanced setting screen 500. Then, the function selected on the function list screen 513 is displayed on the advanced setting screen 500 as the setting 503 for a full press.

When the MENU button is pressed or the return icon 505 is touched by the user on the advanced setting screen 500, the advanced setting screen 500 returns to the setting screen 400.

In the case of AF-ON6, the function set for a half press of the AF-ON button is fixed to “metering and AF start”, so that the function set for the full press of the AF-ON button is limited to a function that can be performed simultaneously with the function “metering and AF start”. For this reason, the number of functions in the second function group displayed on the function list screen 513 is smaller than the number of functions in each the first and third function groups displayed on the function list screens 506 and 512, respectively.

For example, the first and third function groups includes a function for displaying a setting screen, a function for assist with setting, and a function related to playback. Examples of a function for displaying a setting screen include functions for displaying a shooting mode setting screen, menu screen, quick setting screen, and white balance setting screen. Examples of a function for assisting with setting include functions related to lighting of the display panel and switching of display panel information. Examples of a function related to playback include functions related to playback of an image, enlarging a played back image, deleting a played back image, and rating a played back image. These functions are not included in the second function group because they are not related to “metering and AF start”.

### Setting Process to Assign Functions to Half Press and Full Press of AF-ON Button

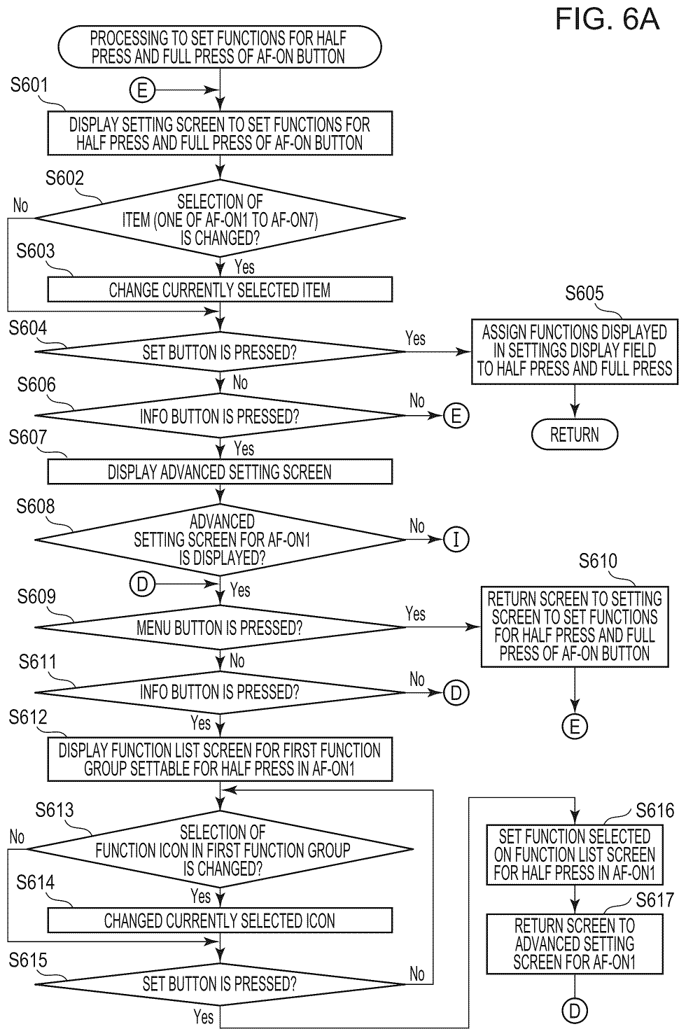

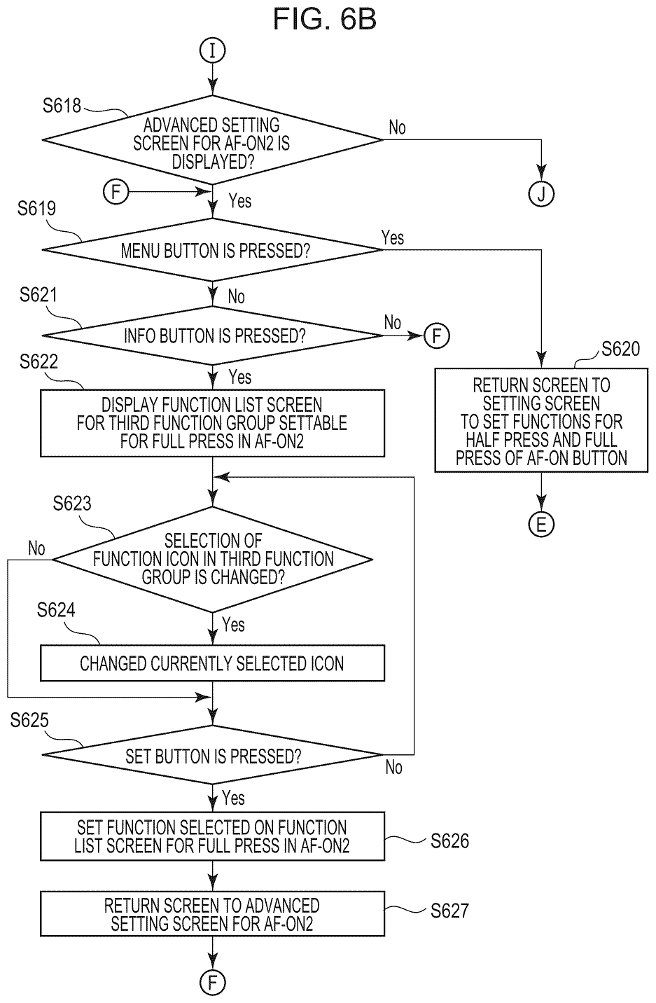

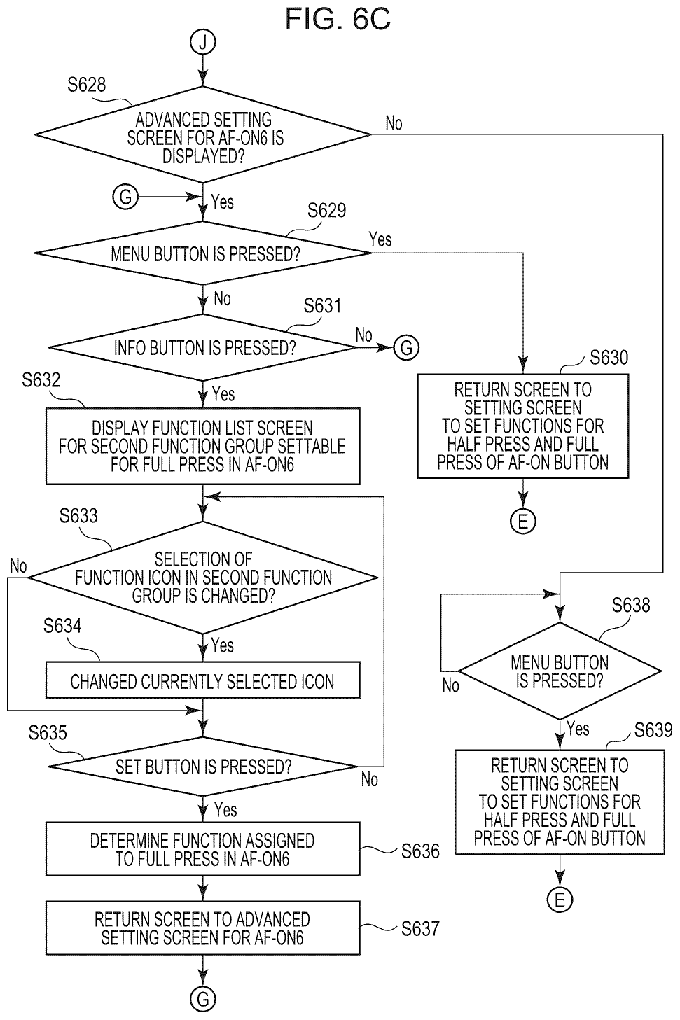

FIGS. 6A to 6C are flowcharts of the setting process (the process in S303) to assign functions to the half press and full press of the AF-ON button 212. As illustrated in FIG. 4D, the combinations of functions each can be set for half press and full press of the AF-ON button 212 are determined in advance. The user can select, from the combinations, the functions to be assigned to a half press and full press of the AF-ON button 212. For the cells with “user setting” in FIG. 4D, a function can be set by user selection. The processing in FIGS. 6A to 6C is realized by loading the program stored in the nonvolatile memory 38 into the volatile memory 39 and executing the program by the system control unit 40.

In S601, the system control unit 40 displays the setting screen 400 used to assign functions to the half press and full press of the AF-ON button.

In S602, the system control unit 40 determines whether the four-way operational key is operated and an instruction to change the selection of an item (one of AF-ON1 to AF-ON7) in the setting screen 400 for the AF-ON button is input by the user. If it is determined that an instruction to change the selection of an item has been input, the processing proceeds to S603. Otherwise, the processing proceeds to S604.

In S603, the system control unit 40 moves the cursor 401 on the setting screen 400, which is used to assign functions to a half press and a full press of the AF-ON button, from the currently selected item to another item to change the currently selected item. The system control unit 40 then displays, in the settings display field 410, the setting 411 for the half press of the AF-ON button and the setting 412 for the full press of the AF-ON button that are set for the currently selected item.

In S604, the system control unit 40 determines whether the SET button is pressed on the setting screen 400 for the AF-ON button. If it is determined that the SET button is pressed, the processing proceeds to S605. Otherwise, the processing proceeds to S606.

In S605, the system control unit 40 assigns the functions displayed in the settings display field 410 on the setting screen 400 to the half press operation and full press operation of the AF-ON button 212. That is, the functions set for the item currently selected on the setting screen 400 are assigned to the half press operation and full press operation of the AF-ON button 212. At this time, if the user determines that the preset function combination is to be continuously used, the preset functions can be assigned to the half press operation and full press operation. However, if there is no user's desired function combination in the preset function combinations, the user can set the desired function for the operation described as “user setting” in FIG. 4D through the processes in S606 and the subsequent steps. As a result, the user's desired function combination can be assigned to the half press operation and full press operation.

In S606, the system control unit 40 determines whether the INFO button is pressed on the setting screen 400. If it is determined that the INFO button is pressed, the processing proceeds to S607. Otherwise, the processing returns to S601.

In S607, the system control unit 40 displays the advanced setting screen 500 for setting the functions for the half press operation and full press operation regarding the item being selected. That is, the system control unit 40 displays the advanced setting screen 500 (for example, FIG. 5A, 5C, or 5E) corresponding to the item selected in S602 and S603. The advanced setting screen 500 displays the item name 501, the setting 502 for a half press of the AF-ON button, and the setting 503 for a full press of the AF-ON button for the currently selected item to be subjected to advanced setting, as well as the advanced setting icon 504 and the return icon 505. As the setting 502 for a half press and the setting 503 for a full press, the preset functions illustrated in FIG. 4D are displayed. For “user setting,” the currently set function (the initially set function or the function changed by the user) is displayed.

In S608, the system control unit 40 determines whether the advanced setting screen for AF-ON1 among the items is displayed. If it is determined that the advanced setting screen for AF-ON1 is displayed, the processing proceeds to S609. Otherwise, the processing proceeds to S618.

In S609, the system control unit 40 determines whether the MENU button is pressed on the advanced setting screen for AF-ON1. If it determines that the MENU button is pressed, the processing proceeds to S610. Otherwise, the processing proceeds to S611.

In S610, the system control unit 40 performs control so that the screen returns to the setting screen 400 for the AF-ON button, and the processing proceeds to S601. At this time, since the advanced setting screen 500 for AF-ON1 is returned to the setting screen 400 for the AF-ON button, AF-ON1 is selected with the cursor 401 on the setting screen 400 for the AF-ON button, as illustrated in FIG. 4A. In addition, when the screen returns to the setting screen 400 for the AF-ON button, the functions that are currently set for the half press and the full press in AF-ON1 and that are displayed as the setting 502 for a half press and the setting 503 for a full press are displayed as the setting 411 and the setting 412, respectively.

In S611, the system control unit 40 determines whether the INFO button is pressed on the advanced setting screen 500 for AF-ON1. If it is determined that the INFO button is pressed, the processing proceeds to S612. Otherwise, the processing returns to S609.

In S612, the system control unit 40 displays the function list screen 506 (FIG. 5B) that displays the first function group of functions each can be selected as a function settable for a half press of the AF-ON button 212 in the item corresponding to AF-ON1.

In S613, the system control unit 40 determines whether the four-way operational key is operated and an instruction to change the selection of the function icon on the function list screen 506 is input by the user. If it is determined that an instruction to change the selection of the function icon has been input, the processing proceeds to S614. Otherwise, the processing proceeds to S615.

In S614, the system control unit 40 moves the cursor 509 from the currently selected function icon to another function icon on the function list screen 506, which displays the first function group of functions each can be set for a half press of the AF-ON button, and changes the currently selected function icon.

In S615, the system control unit 40 determines whether the SET button is pressed on the function list screen 506 that displays the first function group of functions each can be set for a half press of the AF-ON button. If it is determined that the SET button is pressed, the processing proceeds to S616. Otherwise, the processing returns to S613.

In S616, the system control unit 40 sets the function currently selected on the function list screen 506 for a half press in AF-ON1.

In S617, the system control unit 40 performs control so that the screen returns to the advanced setting screen 500 for the AF-ON1, and the processing proceeds to S609. At this time, the function selected in S614 is displayed on the advanced setting screen 500 for AF-ON1 as the setting 502 for a half press.

In S618, the system control unit 40 determines whether the advanced setting screen 500 for AF-ON2 among the items is displayed. If it is determined that the advanced setting screen 500 for AF-ON2 is displayed, the processing proceeds to S619. Otherwise, the processing proceeds to S628.

In S619, the system control unit 40 determines whether the MENU button is pressed on the advanced setting screen 500 for AF-ON2. If it is determined that the MENU button is pressed, the processing proceeds to S620. Otherwise, the processing proceeds to S621.

In S620, the system control unit 40 performs control so that the screen returns to the setting screen 400 for the AF-ON button, and the processing proceeds to S601. At this time, since the advanced setting screen 500 for AF-ON2 is returned to the setting screen 400 for the AF-ON button, AF-ON2 is selected with the cursor 401 on the setting screen 400 for the AF-ON button, as illustrated in FIG. 4B. In addition, when the screen returns to the setting screen 400 for the AF-ON button, the functions currently set for the half press and full press in AF-ON2 and displayed as the setting 502 for a half press and the setting 503 for a full press are displayed as the setting 411 and the setting 412, respectively.

In S621, the system control unit 40 determines whether the INFO button is pressed on the advanced setting screen 500 for AF-ON2. If it is determined that the INFO button is pressed, the processing proceeds to S622. Otherwise, the processing returns to S619.

In S622, the system control unit 40 displays the function list screen 512 (FIG. 5D) that displays the third function group of functions each can be selected as a function settable for a full press of the AF-ON button 212 in the item corresponding to AF-ON2. The third function group includes the same functions as in the first function group. That is, the first function group and the third function group include the same number and types of functions.

AF-ON1 and AF-ON2 are also the options selected when the user desires to use either the half press operation or the full press operation, as described below. In the case where the user desires to use only one of the operations, if a function group of functions that can be set for the half press operation is the same as a function group of functions that can be set for the full press operation, it is easy for the user to use.

In S623, the system control unit 40 determines whether the four-way operational key is operated and an instruction to change the selection of a function icon on the function list screen 512 is input by the user. If it is determined that an instruction to change the selection of a function icon has been input, the processing proceeds to S624. Otherwise, the processing proceeds to S625.

In S624, the system control unit 40 moves the cursor 509 from the currently selected function icon to another function icon on the function list screen 512, which displays the third function group of functions each can be set for the full press of the AF-ON button, and changes the currently selected function icon.

In S625, the system control unit 40 determines whether the SET button is pressed on the function list screen 512 that displays the third function group of functions each can be set for a full press of the AF-ON button. If it is determined that the SET button is pressed, the processing proceeds to S626. Otherwise, the processing proceeds to S623.

In S626, the system control unit 40 sets the function currently selected on the function list screen 512 for a full press in AF-ON2.

In S627, the system control unit 40 performs control so that the screen returns to the advanced setting screen 500 for AF-ON2, and the processing proceeds to S619. At this time, the function selected in S624 is displayed on the advanced setting screen 500 for AF-ON2 as the setting 503 for a full press.

In S628, the system control unit 40 determines whether the advanced setting screen 500 for AF-ON6 among the items is displayed. If it is determined that the advanced setting screen 500 for AF-ON6 is displayed, the processing proceeds to S629. Otherwise, the processing proceeds to S638.

In S629, the system control unit 40 determines whether the MENU button is pressed on the advanced setting screen 500 for AF-ON6. If it is determined that the MENU button is pressed, the processing proceeds to S630. Otherwise, the processing proceeds to S631.

In S630, the system control unit 40 performs control so that the screen returns to the setting screen 400 for the AF-ON button, and the processing proceeds to S601. At this time, since the advanced setting screen 500 for AF-ON6 is returned to the setting screen 400 for the AF-ON button, AF-ON6 is selected with the cursor 401 on the setting screen 400 for the AF-ON button, as illustrated in FIG. 4C. When returning the screen to the setting screen 400 for the AF-ON button, the system control unit 40 displays, as the settings 411 and 412, the functions that are currently set for a half press and full press in AF-ON6 and are displayed as the setting 502 for a half press and the setting 503 for a full press, respectively.

In S631, the system control unit 40 determines whether the INFO button is pressed on the advanced setting screen for AF-ON6. If it is determined that the INFO button is pressed, the processing proceeds to S632. Otherwise, the processing returns to S629.

In S632, the system control unit 40 displays a function list screen 513 (FIG. 5F) that displays the second function group of functions each can be selected as a function settable for a full press of the AF-ON button 212 in the item corresponding to AF-ON6.

Like steps S304 to S310 in FIG. 3, when a half press operation and a full press operation are performed in sequence, the function assigned to the half press operation and the function assigned to the full press operation are performed in sequence. That is, immediately after the function assigned to the half press operation is performed, a function related to the performed function is performed. Therefore, the second function group is limited to the functions that can be performed after the function assigned to the half press operation of the AF-ON button is performed. Alternatively, instead of limiting the second function group to the functions that can be performed after the function assigned to the half press operation of the AF-ON button is performed, the second function group can be limited to functions related to the functions assigned to the half press operation of the AF-ON button. Since the half press operation and the full press operation are successive operations performed on the same AF-ON button 212, the related operations achieve more excellent operationality. Since, as described above, the second function group is restricted in its functions, the number of functions in the second function group is less than the number of functions in the first and third function groups.

In S633, the system control unit 40 determines whether the four-way operational key is operated and an instruction to change the selection of a function icon in the function list screen 513 is input by the user. If it is determined that an instruction to change the selection of a function icon has been input, the processing proceeds to S634. Otherwise, the processing proceeds to S635.

In S634, the system control unit 40 moves the cursor 509 from the currently selected function icon to another function icon on the function list screen 513, which displays the second function group of functions each can be set for a full press of the AF-ON button, and changes the currently selected function icon.

In S635, the system control unit 40 determines whether the SET button is pressed on the function list screen 513 that displays the second function group of functions each can be set for a full press of the AF-ON button. If it is determined that the SET button is pressed, the processing proceeds to S636. Otherwise, the processing proceeds to S633.

In S636, the system control unit 40 sets the function currently selected on the function list screen 513 for the full press in AF-ON6.

In S637, the system control unit 40 performs control so that the screen returns to the advanced setting screen 500 for AF-ON6, and the processing proceeds to S629. At this time, the function selected in S634 is displayed as the setting 503 for a full press on the advanced setting screen 500 for AF-ON6.

If, in S628, it is determined that the advanced setting screen 500 for AF-ON 6 is not displayed, the advanced setting screen 500 for any one of AF-ON3, AF-ON4, AF-ON5, and AF-ON7 is displayed. On the advanced setting screen 500 for AF-ON3, AF-ON4, AF-ON5, or AF-ON7, a function is set for the full press and half press, and the user is not allowed to change the function and, therefore, the setting 502 for a half press and the setting 503 for a full press are displayed in a grayed out display mode. Since the function cannot be changed for the setting 502 for a half press and the setting 503 for a full press, the advanced setting icon 504 is not displayed, and the screen is not changed to the function list screen even if the INFO button is operated.

In S638, while displaying the advanced setting screen for any one of AF-ON 3, AF-ON4, AF-ON5, and AF-ON7, the system control unit 40 determines whether the MENU button is pressed. If it is determined that the MENU button is pressed, the processing proceeds to S639. Otherwise, the processing returns to S638.

In S639, the system control unit 40 performs control so that the screen returns to the setting screen 400 used to assign functions to a half press and full press of the AF-ON button, and the processing proceeds to S601.

As described above, if, as in AF-ON1 and AF-ON2, a function is not set for one of a half press and a full press, there is no need to limit the options of selection of functions to be set for the other. This increases the degree of freedom in setting a function for the AF-ON button 212. If the user desires to use only the half press operation in which the button is pressed with weak force to perform the function assigned to the half press operation, it is possible to set no function for a full press operation. If the user desires to use only the full press operation in which the button is pressed with strong force to perform the function assigned to the full press operation, it is possible to set no function for the half press operation. This enables switching between the combinations of functions assigned to the half press operation and full press operation in accordance with the user's usage.

Furthermore, when, as in AF-ON6, a function is set for one of the half press and full press operations and “user setting” is set for the other operation, the function is limited as follows. That is, in accordance with the function set for one operation, the functions that can be selected for the other operation in the case of “user setting” are limited. This enables an appropriate combination of functions to be assigned to the half press operation and full press operation.

According to the above-described embodiment, when “metering and AF start” is preset for a half press and “user setting” is set for a full press in AF-ON6, functions that can be set for the full press in AF-ON6 are limited to the functions related to “metering and AF start”. However, an item corresponding to AF-ON8 can be provided in which the “metering and AF start” function is preset for a full press, and “user setting” is set for a half press. In this case, when a function is set for the half press in AF-ON8 using the function list screen, the settable functions for the half press can be limited to functions that can be executed simultaneously with the function set for the full press among the functions of the second function group.

### Second Embodiment

The basic configuration of an image pickup device 200 according to the second embodiment is the same as that according to the first embodiment and, therefore, description of the configuration is omitted. According to the second embodiment, like the first embodiment, the user selects one of the items corresponding to AF-ON1 to AF-ON7, which are combinations of functions that can be set for the half press operation and full press operation. In addition, the user can set a desired combination of functions for the half press and full press operations.

(1) Case where User Sets “Shooting Mode Setting” for Half Press Operation of AF-ON Button

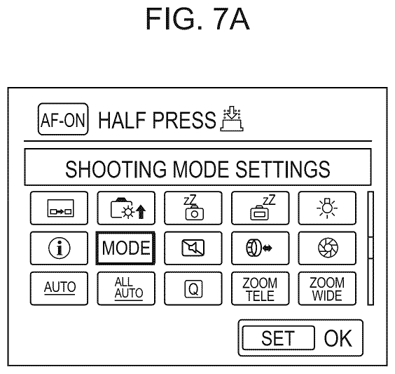

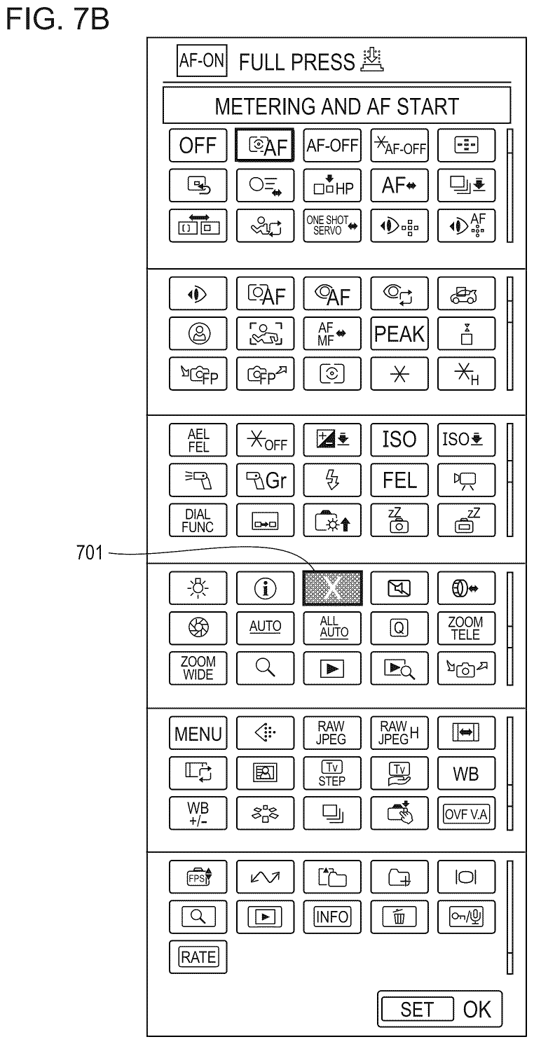

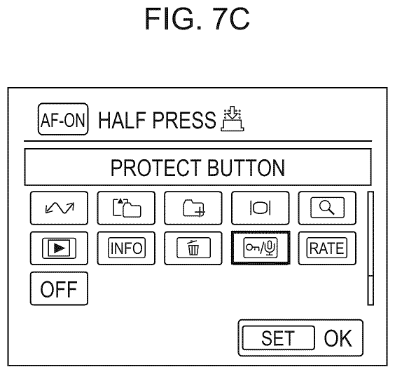

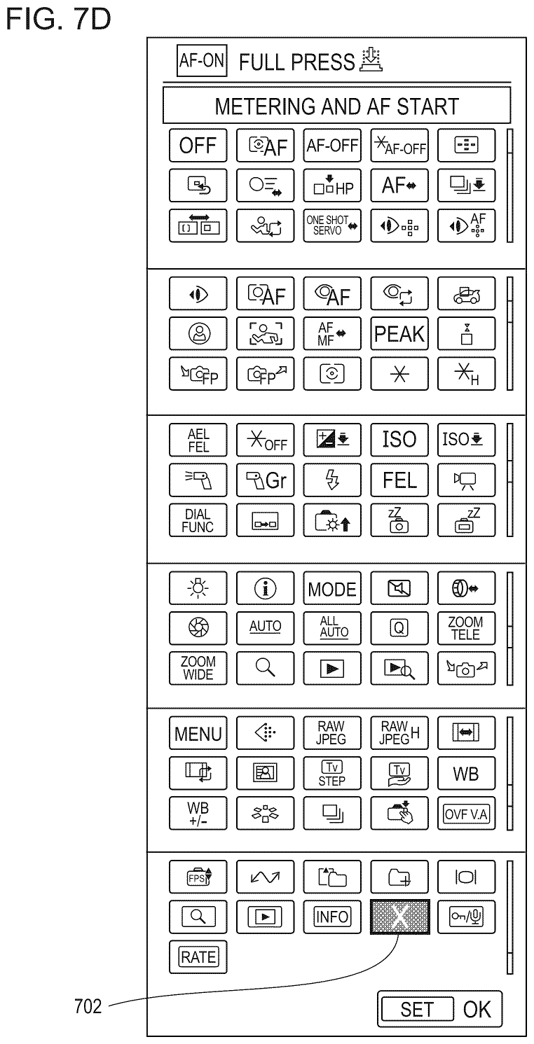

FIGS. 7A to 7D illustrate the advanced setting screens for the AF-ON button. When a user does “shooting mode setting” for a half press operation of the AF-ON button 212 (FIG. 7A), a function list screen is displayed to display a fourth function group that can be set for a full press operation of the AF-ON button (FIG. 7B). As illustrated in FIG. 7B, an icon 701 for the shooting mode selection function included in the fourth function group is displayed as an “X” icon in a grayed out display mode and, thus, is unselectable.

If the processes to be performed by two operations are the same and then, the user performs the two operations, the processes to be performed can become disabled. To avoid such a case, among the functions that can be set for a full press, the function set for the half press is made unselectable so that the function set for the half press is different from the function set for the full press. This prevents the screen for shooting mode setting from disappearing even if a half press operation is performed and then a full press operation is accidentally performed by the user.

(2) Case where User Sets “Protect Button” for Half Press Operation of AF-ON Button

If the user has set “protect button” for a half press operation of the AF-ON button 212 (FIG. 7C), a function list screen is displayed that displays the fifth function group of functions each can be set for a full press of the AF-ON button (FIG. 7D). As illustrated in FIG. 7D, the icon 702 for the image deletion function included in the fifth function group is displayed as an “X” icon in a grayed out display mode and, thus, is unselectable.

If an image protected by a function for marking an image as significant is deleted due to an erroneous operation, the user suffers a loss. To avoid such a case, the image deletion function in the fifth function group is made unselectable. This prevents an image from being deleted even if even a half press operation is performed and then a full press operation is accidentally performed by the user.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-192787 filed Nov. 13, 2023, which is hereby incorporated by reference herein in its entirety.

What is claimed is:

1. An image pickup device comprising:
a first operation member that can receive a first press operation followed by a second press operation having a pressing amount greater than a pressing amount of the first press operation;
a memory storing a program; and
a controller, that when executing the program, causes the image pickup device to:
assign a function to the first press operation and the second press operation based on a user selection;
perform a process corresponding to the function assigned to the first press operation in response to the first press operation and perform a process corresponding to the function assigned to the second press operation in response to the second press operation; and
perform control such that if no function is assigned to the first press operation, the function to be assigned to the second press operation is selected from a first function group that includes a function related to playback, and if a function is assigned to the first press operation, a function to be assigned to the second press operation is selected from a second function group that includes fewer functions than the first function group and that does not include a function related to playback.

2. The image pickup device according to claim 1, wherein if no function is assigned to the first press operation, the controller does not perform any process in response to the first press operation.

3. The image pickup device according to claim 1, wherein the second function group includes a function that is related to photographing and that is assigned to the first press operation.

4. The image pickup device according to claim 1, wherein if a function to perform autofocus is assigned to the first press operation, the controller performs control such that the function to be assigned to the second press operation is selected from a function group related to autofocus.

5. The image pickup device according to claim 1, wherein if no function is assigned to the second press operation, the controller performs control such that the function to be assigned to the first press operation is selected from a third function group that is different from the second function group.

6. The image pickup device according to claim 5, wherein the first function group and the third function group are the same function group.

7. The image pickup device according to claim 1, wherein the first function group includes a function related to photographing and a function related to playback, and
wherein the second function group does not include a function related to photographing and includes a function related to playback.

8. The image pickup device according to claim 1, further comprising
a second operation member that is different from the first operation member and that can receive the first press operation and the second press operation,
wherein the second operation member is used to provide an image shooting instruction.

9. The image pickup device according to claim 1, wherein the first operation member is an operating member that is different from a shutter release button.

10. The image pickup device according to claim 1, wherein the first press operation is a half press operation performed on the first operation member, and the second press operation is a full press operation performed on the first operation member.

11. The image pickup device according to claim 1, wherein the controller assigns, to the first press operation and the second press operation, functions set in an item selected from among a plurality of items in each of which a function to be assigned to the first press operation and a function to be assigned to the second press operation are preset based on a user operation.

12. The image pickup device according to claim 11, wherein the plurality of items include an item in which functions to be assigned to the first press operation and the second press operation are fixed and an item in which a function to be assigned to either the first press operation or the second press operation is changeable in based on a user operation.

13. The image pickup device according to claim 12, wherein the controller performs control such that
for an item in which a function to be assigned to the first press operation is not set and a function to be assigned to the second press operation is changeable by a user operation, the function to be set for the second press operation is selected from the first function group, and for an item in which a function to be assigned to the first press operation is set and a function to be assigned to the second press operation is changeable by a user operation, the function to be set for the second press operation is selected from the second function group.

14. The image pickup device according to claim 12, wherein the controller further causes the image pickup device to select one of the plurality of items based on a user operation, and to perform control to display a combination of the functions set for the first press operation and the second press operation in the selected item.

15. The image pickup device according to claim 14, wherein in response to a user operation for determining the selected item, the controller assigns the functions set in the selected item to the first press operation and the second press operation.

16. A method for controlling an image pickup device including a first operation member that can receive a first press operation followed by a second press operation having a pressing amount greater than a pressing amount of the first press operation, the method comprising:
assigning a function to the first press operation and the second press operation based on a user selection;
performing a process corresponding to the function assigned to the first press operation in response to the first press operation and performing a process corresponding to the function assigned to the second press operation in response to the second press operation; and
performing control such that if no function is assigned to the first press operation, the function to be assigned to the second press operation is selected from a first function group that includes a function related to playback, and
if a function is assigned to the first press operation, a function to be assigned to the second press operation is selected from a second function group that includes fewer functions than the first function group and that does not include a function related to playback.

17. A non-transitory computer-readable storage medium storing one or more programs including executable instructions, which when executed by a computer, cause the computer to
assign a function to the first press operation and the second press operation based on a user selection;
perform a process corresponding to the function assigned to the first press operation in response to the first press operation and perform a process corresponding to the function assigned to the second press operation in response to the second press operation; and
perform control such that if no function is assigned to the first press operation, the function to be assigned to the second press operation is selected from a first function group that includes a function related to playback, and
if a function is assigned to the first press operation, a function to be assigned to the second press operation is selected from a second function group that includes fewer functions than the first function group and that does not include a function related to playback.
